(19) United States
(12) Patent Application Publication
(10) Pub. No.: US 2006/0150082 A1
(43) Pub. Date: Jul. 6, 2006

(54) Multimodal markup language tags

(76) Inventors: Samir Raiyani, Sunnyvale, CA (US); Matthias Winkler, Dresden (DE); Ju-Kay Kwek, San Francisco, CA (US); Wai Or, Hayward, CA (US); John Hanley, Redwood City, CA (US)

Correspondence Address: FISH & RICHARDSON, P.C., PO BOX 1022, MINNEAPOLIS, MN, 55440-1022, US

(21) Appl. No.: 11/025,594

(22) Filed: Dec. 30, 2004

(51) Int. Cl. G06F 17/00

(52) U.S. Cl. 715/513

(57) ABSTRACT

A multimodal system may include a user device, a multimodal application, and an application server. The user device includes a multimodal browser operable to receive web content in a multimodal markup language for presentation. The multimodal application includes interfaces implemented as server pages using multimodal markup language tags including tag attributes. The multimodal markup language tags are operable to present interface elements of the server pages in one or more modes and to accept input associated with the interface elements in one or more input modalities. The application server is operable to process the multimodal markup language tags such that the server pages implemented using the multimodal markup language tags can be displayed on the multimodal browser.

### TECHNICAL FIELD

Particular implementations relate generally to multimodal markup language tags.

### BACKGROUND

A user may interface with a machine in many different modes, such as, for example, a mechanical mode, an aural mode, and a visual mode. A mechanical mode may include, for example, using a keyboard for input. An aural mode may include, for example, using voice input or output. A visual mode may include, for example, using a display output. This type of interaction, in which a user has more than one means of accessing data by interacting with a user device, is referred to as multimodal interaction.

To assist users in interacting with user devices such as, for example, personal digital assistants (PDAs) and personal computers (PCs), user interface designers have begun to combine traditional keyboard-input modes with other interaction modes in which the user has multiple modes available for accessing data in the user device.

### SUMMARY

In a general aspect, a multimodal system includes a user device, a multimodal application, and an application server. The user device includes a multimodal browser operable to receive web content in a multimodal markup language for presentation. The multimodal application includes interfaces implemented as server pages using multimodal markup language tags including tag attributes. The multimodal markup language tags are operable to present interface elements of the server pages in one or more modes and to accept input associated with the interface elements in one or more input modalities. The application server is operable to process the multimodal markup language tags such that the server pages implemented using the multimodal markup language tags can be displayed on the multimodal browser.

Implementations may include one or more of the following features. For example, the server pages may be Java Server Pages (JSPs). The tag attributes may relate to a type, format, or appearance associated with the interface elements of the server pages.

The application server may include a tag library operable to define the multimodal markup language tags used to implement the server pages, a servlet container operable to evaluate the multimodal markup language tags, and web templates operable to be populated with attribute values extracted from the multimodal markup language tags. The tag library may include a tag library descriptor file (TLD) operable to describe the multimodal markup language tags used to implement the interfaces, and tag handlers operable to define functionality associated with each of the multimodal markup language tags. The servlet container may be a JSP container.

In another general aspect, a multimodal markup language tag having one or more attribute values is provided, the multimodal markup language tag being used to implement a server page. A tag handler is called, the tag handler having been associated with the multimodal markup language tag. The one or more attribute values are extracted from the multimodal markup language tag. A web template is selected, the web template having been associated with the multimodal markup language tag. The web template is populated with the attribute values.

Implementations may include one or more of the following features. For example, the template contents may be written to a writer, and a servlet associated with the server page may be compiled and executed. The writer may be a JSPWriter.

In another general aspect, a system includes a mobile device, an application, a tag library, web templates, and an extensible hypertext markup language plus voice (X+V) tag handler. The mobile device includes a multimodal browser operable to present web content implemented using X+V. The application has been developed using X+V tags operable to implement a voice-enabled and/or multimodal user interface. The tag library is operable to store a set of X+V tags. The web templates have been written in X+V code and associated with the set of X+V tags. The X+V tag handler is operable to interpret an X+V tag, read one or more attribute values associated with the X+V tag, and populate the one or more attribute values with one or more of the web templates. Using the one or more of the web templates, X+V code is generated to create voice-enabled and/or multimodal web content.

Implementations may include one or more of the following features. For example, the set of X+V tags may be developed (i) based on various usage scenarios of the system, or using a Java Server Page tag library schema. The set of X+V tags may include (i) an xv:head tag operable to write out standard X+V header tags, (ii) an xv:input tag operable to provide functionality to voice-enable text-input field, (iii) an xv:input-checkbox tag operable to provide functionality to voice-enable a checkbox, (iv) an xv:input-built-in tag operable to provide functionality to voice-enable an input field using one of a variety of built-in VoiceXML types, (v) an xv:message tag operable to display an acoustic message to a user without requiring receipt of feedback from the user, (vi) an xv:confirmation tag operable to provide confirmation functionality to voice-enabled X+V interface elements, (vii) an xv:listselector tag operable to voice-enable a set of links, (viii) an xv:submit tag operable to provide functionality to voice-enable a submit button, (ix) an xv:input-scan tag operable to read data from a barcode into a barcode string field, or (x) an xv:input-builtin-restricted tag operable to enable restricted input of numbers into a text field. The tag library may include a tag library descriptor file (TLD) operable to describe the multimodal markup language tags used to implement the interfaces, and tag handlers operable to define functionality associated with each of the multimodal markup language tags.

The details of one or more implementations are set forth in the accompanying drawings and the description below. Other features of particular implementations will be apparent from the description, the drawings, and the claims.

### DESCRIPTION OF DRAWINGS

FIG. 1 shows an implementation of a system for using multimodal markup language tags.

FIG. 2 is a flow chart of a process for evaluating multimodal markup language tags.

FIG. 3 shows an implementation of a multimodal warehousing system.

FIGS. 4A and 4B show examples of multimodal warehousing application interfaces implemented using multimodal markup language tags.

### DETAILED DESCRIPTION

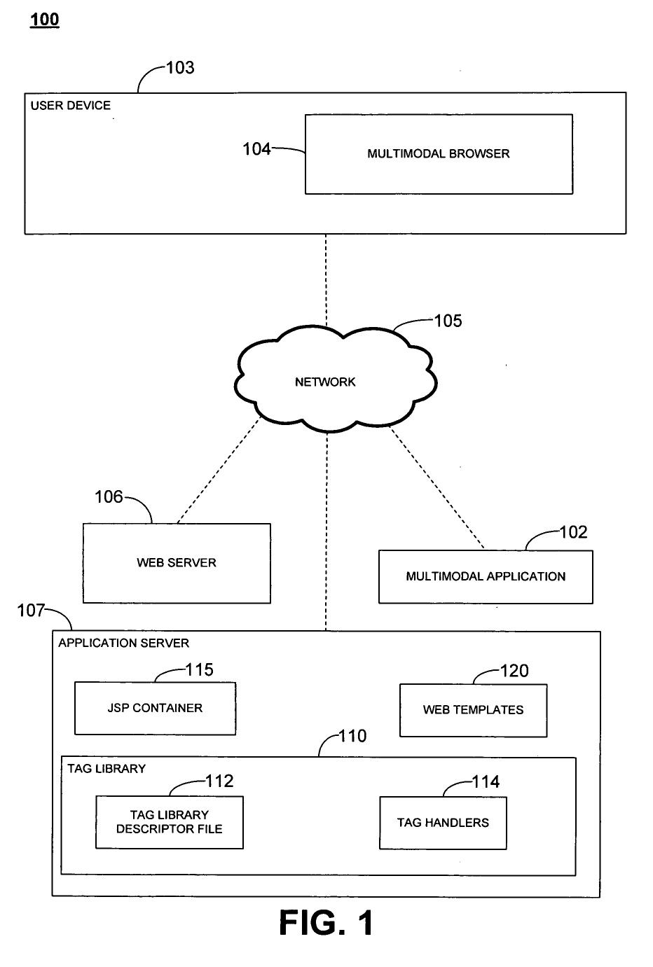

FIG. 1 is an implementation of a system 100 for using multimodal markup language tags. A set of multimodal markup language tags may be developed that cover basic usage scenarios and functions associated with the system 100. A multimodal markup language tag refers to a character string that identifies a type, format, appearance, and/or function associated with an element of a multimodal user interface, referred to herein as an interface element. An interface element may be, for example, a text field, password field, checkbox, radio button, or control button (e.g., submit and reset). Additionally, a multimodal markup language tag may be operable to present an interface element in one or more modes (e.g. an aural mode and a visual mode), and is operable to accept input associated with the interface element in one or more input modalities (e.g. a manual mode and an aural mode). A multimodal markup language may be associated with attribute values which serve as parameters used to define an interface element corresponding to the multimodal markup language tag. Tag attributes may be populated by a multimodal markup language tag's user (e.g. a programmer).

Each multimodal markup language tag may correspond to an underlying and reusable portion of multimodal markup language code which implements features and functionality of an interface element. The underlying multimodal markup language code may never be seen by a user of the multimodal markup language tag. Thus, the multimodal markup language tags are implemented such that a programmer developing software and systems using the tags need not have an extensive knowledge of a (sometimes more complex) multimodal markup language that the multimodal markup language tags correspond to. The multimodal markup language tags may automate application development. Examples of multimodal markup languages include Multimodal Presentation Markup Language (MPML), Extensible Multimodal Annotation Markup Language (EMMA), and Extensible Hypertext Markup Language plus Voice (X+V).

In one implementation, a set of X+V tags may be generated for use in implementing an X+V-based application. X+V is a web markup language for developing multimodal applications that include both visual and voice interface elements. If a programmer were to develop a web application, such as, for example, a form (a form refers to a formatted document containing blank fields that application users may fill in with data), using X+V, the programmer would have to have knowledge of technologies underlying X+V. For example, the programmer would need knowledge of Extensible Hypertext Markup Language (XHTML), Extensible Markup Language (XML) Events, and Voice Extensible Markup Language (VXML) in order to develop an application using X+V. In contrast, developing an X+V based application using X+V tags does not require a user to have knowledge of such technologies as XHTML, XML Events, and VXML. A programmer using a multimodal markup language tag (e.g. an X+V tag) may need only to enter appropriate attribute values into the multimodal markup language tag in order to generate an interface element associated with the multimodal markup language tag. However, a programmer using a multimodal markup language (e.g. X+V) to generate the same interface element may need to write large amounts of multimodal markup language code. Thus, the use of multimodal markup language tags may significantly speed up the multimodal application development process.

In the illustrated example, multimodal markup language tags may be used to develop portions of a multimodal application 102. In general, the multimodal application 102 is any association of logical statements that dictate the manipulation of data in one or more formats using one or more input modalities. In one implementation, a first input modality may be associated with voice inputs and a first format including Voice Extensible Markup Language (VXML). For example, the voice inputs may be used to manipulate VXML data. A second input modality may be associated with Radio Frequency Identification (RFID) signal inputs. The second input modality may be associated with a Hyper Text Markup Language (HTML) page, and therefore, a second format is HTML. For example, the RFID signal inputs may initiate access to a corresponding HTML page.

In the illustrated example, the application 102 is a world wide web-enabled application. In general, the world wide web, also referred to as the web, refers to a system of internet servers that uses Hypertext Transfer Protocol (HTTP) to transfer specially formatted documents. HTTP refers to a set of rules for transferring files (e.g. text, graphic images, sound, video, and other multimedia files) on the world wide web.

Employing a user device 103 equipped with a multimodal browser 104, a user may interact with interfaces of the multimodal application 102 via a network 105. The network 105 may be one of a variety of established networks, such as, for example, the Internet, a Public Switched Telephone Network (PSTN), the world wide web, a wide-area network (“WAN”), a local-area network (“LAN”), or a wireless network. The user device 103 may be any appropriate device for receiving information from the multimodal application 102, presenting the information to a user, and receiving input from the user. The user device 103 may be, for example, a PC, a PDA, or a cellular phone with text messaging capabilities.

In the illustrated example, interactions between the multimodal browser 104 of the user device 103 and web-enabled interfaces of the multimodal application 102, are managed by a web server 106 and an application server 107. In general, a web server, such as the web server 106, processes HTTP requests received from a web browser, such as the multimodal browser 104. When the web server 106 receives an HTTP request, it responds with an HTTP response, for example, sending back an HTML page. To process a request the web server 106 may respond with a static HTML page or image, or may delegate generation of the HTTP response to another program, such as, for example Common Gateway Interface (CGI) scripts, Java Server Pages (JSPs), Active Server Pages (ASPs), server-side JavaScripts, or another suitable server-side technology.

The multimodal browser 104 is operable to receive web content in a multimodal markup language for presentation to a user. The multimodal browser 104 is operable to present the information to the user in one or more formats, and is operable to receive inputs from the user in one or more modalities for manipulating the presented information. In one implementation, the multimodal browser 104 may present web content to a user in the form of pages. As an example, the multimodal browser 104 may display pages in a visual mode and in an aural mode. A user may be able to click (manual input) buttons, icons, and menu options to view and navigate the pages. Additionally, a user may be able to enter voice commands (aural input) using, for example, a microphone, to view and navigate the pages.

A page may be, for example, a content page or a server page. A content page includes a web page (e.g. an HTML page), which is what a user commonly sees or hears when browsing the web. A server page includes a programming page (i.e., a page containing one or more embedded programs) such as, for example, a JSP. A server page also may include content. For example, a JSP may include HTML code.

In the illustrated example, the web server 106 presents pages for viewing with the multimodal browser 104. The multimodal browser 104 may be used to generate HTTP requests to, for example, access an interface of the multimodal application 102. The HTTP requests may be delegated by the web server 106 to the application server 107. In general, an application server provides access to program logic, such as for example, data and method calls, for use by client application programs. Program logic refers to an implementation of the functionality of an application. In the system 100, the application server 107 provides access to program logic for use by the multimodal application 102. In the system 100, the program logic associated with the multimodal application 102 and stored on the application server 107 is implemented using JSP technology. JSPs provide a simplified, fast way to create dynamic web content. In other implementations, program logic associated with the multimodal application 102 may be developed using server pages and/or any other appropriate server-side technology.

A tag library 110 is stored on the application server 107. The tag library 110 is associated with a set of multimodal markup language tags created for the system 100. For example, the aforementioned X+V tags would be accompanied by an implementation of the tag library 110 to support the X+V tags. The tag library 110 includes a tag library descriptor file (TLD) 112 and tag handlers 114. The TLD 112 and the tag handlers 114 are used to identify and to process multimodal markup language tags.

The TLD 112 contains information about the library 110 as a whole and about each multimodal markup language tag contained in the library 110. The TLD 112 may be used to identify and validate a multimodal markup language tag. Each multimodal markup language tag supported by the tag library 110 is defined by a tag handler class. The tag handlers 114 refer to a collection of the tag handler classes used to define a set of multimodal markup language tags. In some instances, a tag handler class may be used to extract values of attributes from a multimodal markup language tag.

In the illustrated example, the portions of the multimodal application 102 implemented using multimodal markup language tags, are processed by the application server 107 using the tag library 110, a servlet container, for example, a JSP container 115, and web templates 120 to provide multimodal content for presentation in the multimodal browser 104. The JSP container 115 is used to process JSPs of the multimodal application 102 into a servlet. The JSP container 115 uses the tag library 110 to interpret and process multimodal markup language tags in the JSPs of the multimodal application 102 while processing the JSPs into a servlet. In general, a servlet is a small program that runs on a server.

The web templates 120 are pre-fabricated structures of markup language code that may be used in evaluating the JSPs of the multimodal application 102. Using the X+V tags example, the web templates 120 for an X+V system may include XML, XHTML, VXML, and/or JavaScript code. The web templates 120 may function as a framework corresponding to a multimodal markup language tag, where the web templates 120 are to be populated with the attribute values extracted from the multimodal markup language tags. For example, a multimodal markup language tag may be used to implement a form element such as a text field. A web template associated with the text field multimodal markup language tag may contain markup language code for implementing a framework of a text field and its associated function. Attribute values extracted from the multimodal markup language tag, such as, for example, attribute values relating to the length of text strings accepted into the text field, may be used to populate the web template associated with the text field.

The web server 106 receives an HTTP request from the multimodal browser 104 of the user device 103 to access an interface of the multimodal application 102. Interfaces of the multimodal application 102 are implemented as JSPs created using multimodal markup language tags. The web server 106 delegates the HTTP request to the application server 107. The JSP container 115 accesses the TLD 112 and the tag handlers 114 in the tag library 110 to identify and process multimodal markup language tags encountered and read from code within the JSP. Processing a multimodal markup language tag may include extracting attribute values from the multimodal markup language tag. One or more web templates 120 may be selected based on the encountered multimodal markup language tag. The extracted attribute values are loaded into the one or more web templates 120. The JSP container 115 compiles the web templates 120 populated with extracted attribute values from multimodal markup language tags into a servlet. The servlet may then be executed, initiating a HTTP response from the web server 106, and presenting an interface of the multimodal application 102 for accessing with the multimodal browser 104.

Using the system 100, a programmer may create a JSP using multimodal markup language tags. The system 100 translates the multimodal markup language tag-based JSP into a JSP coded in a multimodal markup language, and processes and presents the resulting JSP for accessing with the multimodal browser 104. Using the system 100, a programmer needs only minimal knowledge of a multimodal markup language and/or the technologies underlying a multimodal markup language. A programmer may instead use multimodal markup language tags to automate programming.

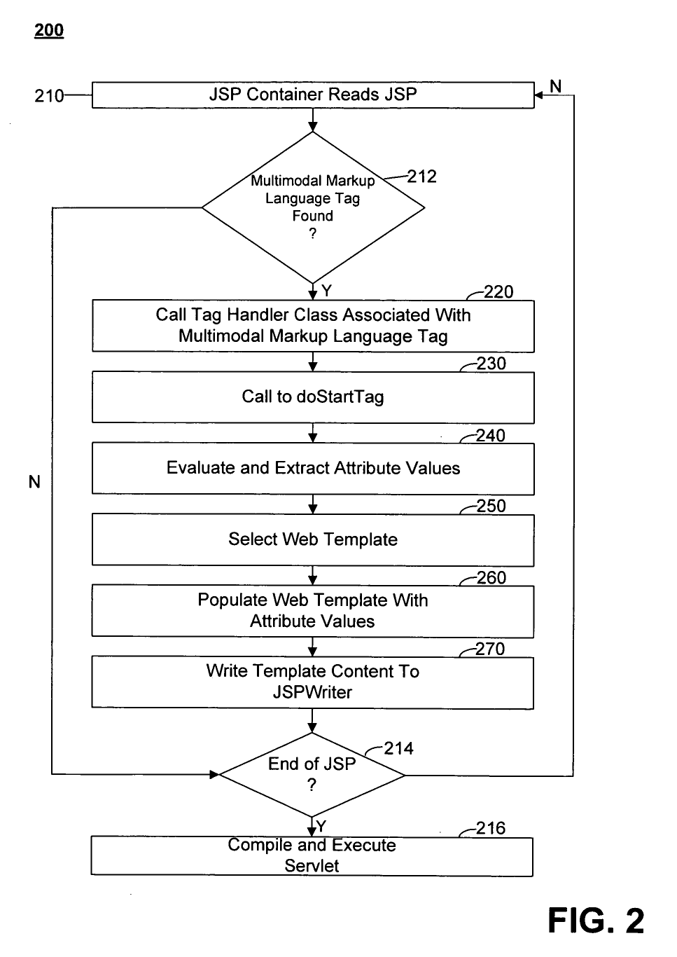

FIG. 2 is a flow chart of a process 200 for evaluating multimodal markup language tags. The process 200 may be implemented by a system similar to the system 100 of the FIG. 1. A JSP created using multimodal markup language tags is read by a JSP container 115 associated with the system implementing the process 200 (210). The process 200 includes a check if a multimodal markup language tag has been found in the JSP (212). If a multimodal markup language tag is not found, the process 200 checks if the end of the JSP has been reached (214). If the end of the JSP has not been reached, the JSP container continues to read the JSP (210). If the end of the JSP has been reached, a servlet associated with the JSP is compiled and executed (216) resulting in presentation of the JSP in a multimodal browser 104.

However, if a multimodal markup language tag is found, a tag handler class associated with the multimodal markup language tag is called (220). The tag handler class to be associated with a multimodal markup language tag is determined by accessing a tag library, such as, for example, the tag library 110. A TLD 112 in the tag library 110 may contain information that may be used to check that the encountered multimodal markup language tag is a valid multimodal markup language tag. Additionally, the TLD 112 contains information relating to which tag handler class is associated with a particular multimodal markup language tag.

Once the determined tag handler class is called, a doStartTag method associated with the tag handler class may be used to evaluate the encountered multimodal markup language tag (230). Attribute values stored in the multimodal markup language tag are evaluated and extracted from the multimodal markup language tag (240). A prefabricated web template (e.g. one or more of the web templates 120) associated with the multimodal markup language tag is then selected (250). The selected web template is populated with the extracted attribute values (260). The template content is then written to a JSPWriter (270). The JSPWriter is a Java language class that prints formatted representations of objects to a text-output stream. In more general implementations, the template content may be written to any language's appropriate Writer class. In the process 200, the JSPWriter may be used to present the JSP page in a multimodal browser, such as, for example, the multimodal browser 104. In one implementation, the steps 240, 250, 260, and 270 all may be implemented by the doStartTag method. As another example, the steps 240, 250, 260, and 270 may be implemented by some combination of the doStartTag method and other methods associated with the tag handler class, such as, for example, a doEndTag method.

The process 200 checks if the end of the JSP has been reached (214). If the end of the JSP has not been reached, the JSP container continues to read the JSP (210). If the end of the JSP has been reached, a servlet associated with the JSP is compiled and executed (216) resulting in presentation of the JSP in a multimodal browser 104.

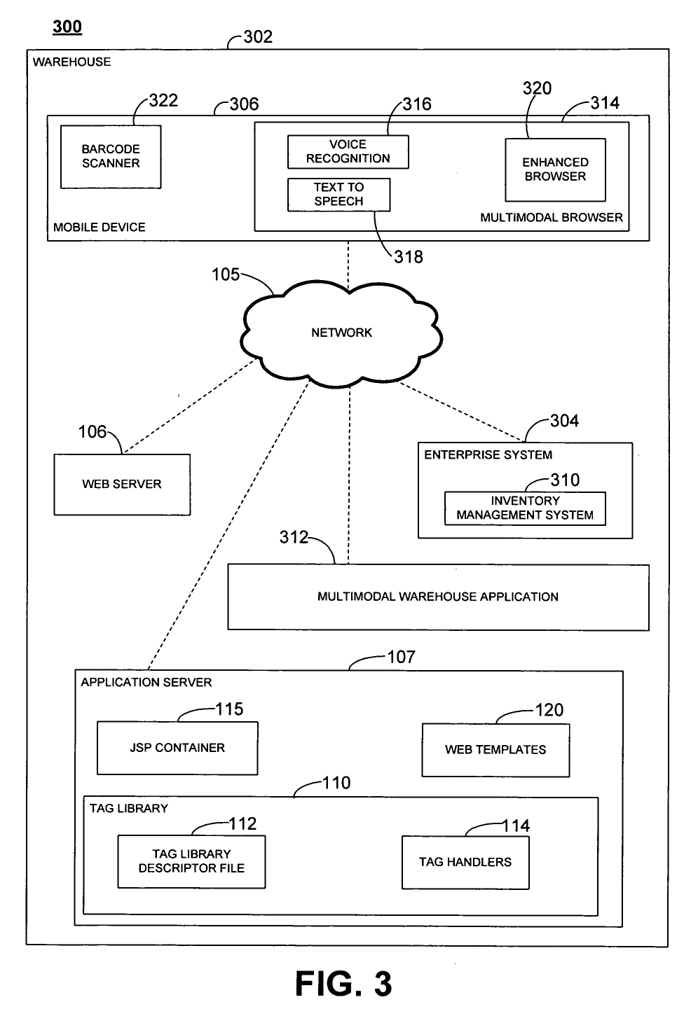

FIG. 3 is an implementation of a multimodal warehousing system 300. The multimodal warehousing system 300 may be similar to the system 100 shown in FIG. 1. The implementation of the system 300 is described in the context of a warehouse 302. More generally, it should be understood that the warehouse 302 represents one or more warehouses for storing a large number of products for sale and distribution in an accessible, cost-efficient manner. For example, the warehouse 302 may represent a site for fulfilling direct mail orders for shipping the stored products directly to customers. The warehouse 302 also may represent a site for providing inventory to a retail outlet, such as, for example, a grocery store. The warehouse 302 also may represent an actual shopping location, i.e., a location where customers may have access to products for purchase.

In FIG. 3, an enterprise system 304 communicates with a mobile device 306 via the network 105. For sake of simplicity, the common elements of the FIGS. 1 and 3 are referenced by the same numbers. The enterprise system 304 may include an inventory management system 310 that stores and processes information related to items in inventory. The enterprise system 304 may be, for example, a standalone system or part of a larger business support system, and may access (via the network 105) both internal databases storing inventory information and/or external databases which may store financial information (e.g. credit card information). Although not specifically shown, access to the internal databases and the external databases may be mediated by various components, such as, for example, a database management system and/or a database server.

Locations and/or associated storage containers throughout the warehouse 302 may be associated with different item types. The enterprise system 304 maintains a storage location associated with a storage container for an item. As a result, the enterprise system 304 may be used to provide warehouse workers with, for example, suggestions on the most efficient routes to take to perform warehousing tasks, such as, for example, collecting items on a pick list to fulfill a customer order.

For example, the enterprise system 304 may provide the mobile device 306 with information regarding items that need to be selected from a storage area. This information may include one or more entries in a list of items that need to be selected. The entries may include a type of item to select (for example, ¼″ phillips head screwdriver), a quantity of the item (for example, 25), a location of the item (that is, stocking location), and an item identifier code, such as a barcode or code associated with an RFID tag. Other information such as specific item handling instructions also may be included.

Warehouses such as the warehouse 302 often are very large and, by design, store large numbers of products in a cost-efficient manner. However, such large warehouses often provide difficulties to a worker attempting to find and access a particular item or type of item in a fast and cost-effective manner, for example, for shipment of the item(s) to a customer. As a result, the worker may spend unproductive time navigating long aisles while searching for an item type.

Additionally, the size and complexity of the warehouse 302 may make it difficult for a manager to accurately maintain proper count of inventory. In particular, it may be the case that a worker fails to accurately note the effects of his or her actions; for example, failing to correctly note the number of items selected from (or added to) a shelf. Even if the worker correctly notes his or her activities, this information may not be properly or promptly reflected in the inventory management system 310.

These difficulties are exacerbated by a need for the worker to use his or her hands when selecting, adding, or counting items, i.e., it is difficult for a worker to simultaneously access items on a shelf and implement some type of item notation/tracking system, for example, running on a mobile device 306. Although some type of voice-recognition system may be helpful in this regard, such a system would need to be fast and accurate, and, even so, may be limited to the extent that typical warehouse noises may render such a system (temporarily) impracticable.

In consideration of the above, a multimodal warehouse application 312 may be implemented allowing a worker multimodal access to warehouse and/or inventory data presented in both an aural mode and/or a visual mode. A set of multimodal markup language tags may be developed that cover basic usage scenarios associated with the system 300. The multimodal markup language tags may then be used to develop the multimodal warehouse application 312. The multimodal warehouse application 312 may be similar to the multimodal application 102 shown in FIG. 1. The multimodal warehouse application 312 may be supported by the web server 106 and the application server 107.

In one scenario, for example, a worker may use a tote to collect, or “pick,” a first item from a shelf. The mobile device 306 may be a portable device, such as a PDA, that may be small enough to be carried by a user without occupying either of the hands of the user (e.g., may be attached to the user's belt). The mobile device 306 may be used to send an HTTP request to the web server 106 to receive inventory data from the enterprise system 304 by interacting with the multimodal warehouse application 312. In one example, the inventory data may be presented as a “pick list” (that is, a list of items to select or pick) in a multimodal browser 314 of the mobile device 306. The multimodal browser 314 may be similar to the multimodal browser 104. The multimodal browser 314 includes voice recognition technology 316 and text-to-speech technology 318 to be used with the aural mode. Additionally, the multimodal browser 314 includes an enhanced browser 320 operable to present data in both the visual and aural modes. Additionally, inventory information also may be accessed by reading a barcode on the first item and/or reading a barcode on a shelf on which the first item is stored using an identification tag scanner 322 on the mobile device 306. Examples of an identification tag scanner include a barcode scanner and an RFID scanner.

Multimodal markup language tags are developed, for example, by a system administrator, to address the scenario described above. The developed multimodal markup language tags are supported by the tag library 110 and the web templates 120 forming part of the application server 107, as described earlier. The multimodal markup language tags may then be used to implement interfaces for the multimodal warehouse application 312 as JSPs. The JSPs may be processed for presentation on the multimodal browser 314 using the tag library 110, the JSP container 115, and the web templates 120.

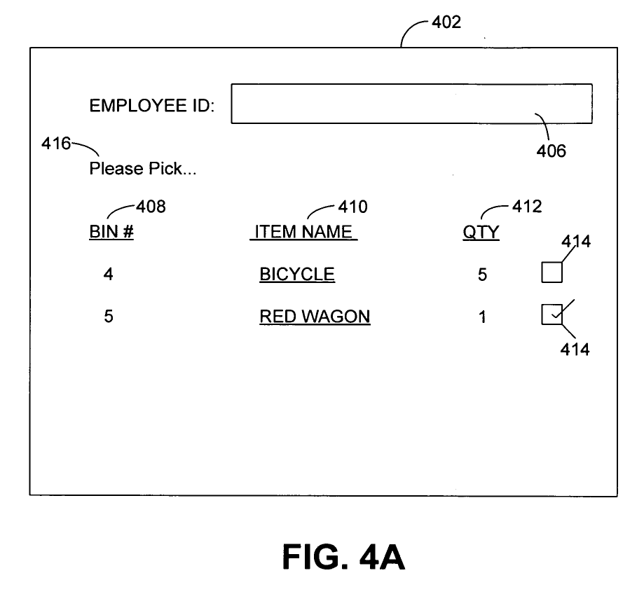

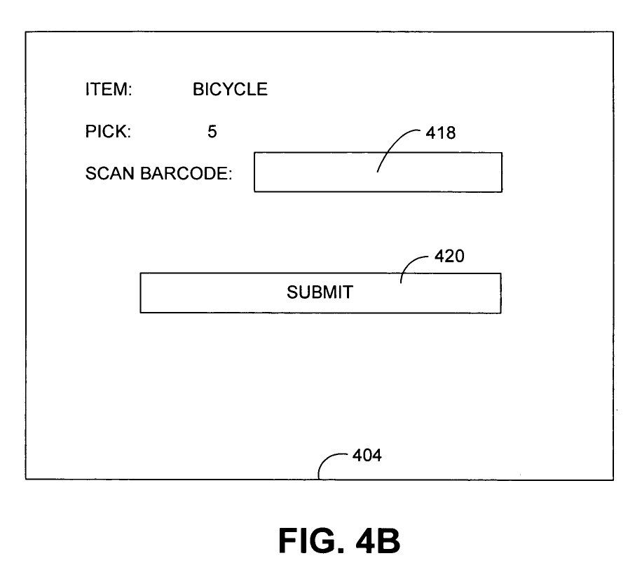

FIGS. 4A and 4B are examples of multimodal warehousing application interfaces 402 and 404, respectively, implemented using multimodal markup language tags. The interfaces 402 and 404 may be generated by the system 300 shown in FIG. 3. The interfaces 402 and 404 may be interfaces for the multimodal warehouse application 312 implemented using, for example, multimodal markup language tags such as X+V tags. The interfaces 402 and 404 may be presented to a user, for example, on a mobile device, such as the mobile device 306. The user may access interface elements of the interfaces 402 and 404 by manually making selections (e.g. clicking with a mouse) or by issuing voice commands.

In FIG. 4A, the interface 402 presents a pick list. The pick list may be generated as a result of a request by a worker to receive inventory data, as described earlier. The interface 402 includes a field 406 where the worker enters an employee ID. Additionally presented as part of a pick list are a bin number 408 where an item may be stored, an item name 410, quantity of an item to be picked 412, and a checkbox 414 to be checked once an item has been picked.

The multimodal markup language tags described herein may be developed to implement the aforementioned features of the interface 402. The multimodal markup language tags may be developed to display an interface element visually, to present an acoustic message, and/or to read and react on the voice, touch or other input of a user. In the example of X+V tags, the tags may be developed to define an XML namespace “xv.” An xv:head tag may be developed to create the interface 402. The xv:head tag may provide attributes for setting page-specific data, such as, for example, a title. Additionally, the xv:head tag may include an optional attribute such as, for example, “onLoadVoicePrompt” which displays a message when the page is loaded.

The employee ID field 406 may be implemented as a text field using an xv:input-text tag. The xv:input-text tag provides the functionality to voice-enable a text-input field. The xv:input-text tag may include an attribute, such as, for example, “inputID” which sets an identification value for the input tag. Additional attributes for this tag may include: “next” to shift to another element in the interface; “prompt” which presents a voice prompt when a user selects the text field; “grammarSource” which verifies a speech recognition grammar to be associated with the text field; “submit” which is a Boolean value as to whether to submit the form when the field is filled; “value” which specifies a default value for the field; and “size” which specifies a size of the input field.

As another example the employee ID field 406 may be implemented using an xv:input-builtin tag. The xv:input-builtin tag provides functionality to voice-enable an input field using one of a variety of built-in VoiceXML type definitions, such as, for example: Boolean, date, digits, currency, number, phone, and time. The xv:input-builtin tag also may include such attributes as: “inputID,” “next,” “prompt,” “builtInType,” “grammarSource,” “submit,” and “value.”

Additionally, the employee ID field 406 may be implemented using an xv:input-builtin-restricted tag, enabling a restricted input of numbers into a text field. The xv:input-builtin-restricted tag uses a built-in grammar for digits. Using a “digits” attribute, a user may be restricted to only input a limited number of digits. Additional attributes may include “inputID,” “next,” “prompt,” “submit,” and “value.”

The checkbox 414 may be implemented using an xv:input-checkbox tag. The xv:input-checkbox tag provides functionality to voice-enable a checkbox. The xv:input-checkbox tag may include such attributes as “inputID”, “next”, “prompt”, “grammarSource”, and “submit.”

A message 416, such as “Please Pick” may be implemented such that the message “please pick” is presented as an acoustic message to the user and is not intended to receive a response from the user. The “Please Pick” message 416 may be implemented using an xv:message tag. The xv:message tag may include such attributes as: “inputID,” “next,” “prompt,” and “submit.”

A message 416, such as “Please Pick” may also be implemented such that the message “please pick” is presented as an acoustic message to the user and requires a response from the user. The “Please Pick” message 416 may be implemented using an xv:confirmation tag. The xv:confirmation tag may include such attributes as: “inputID,” “next,” “prompt,” and “submit.” The confirmation from the user would be expected in the form of a “yes” or “no” verbal response or a click from a user on a button presented on the screen.

The item names 410 may be implemented as a set of links using an xv:listselector tag. The xv:listselector tag may include such attributes as: “inputID,” “id,” “action” which may specify a Uniform Resource Locator (URL) to which the link connects, “prompt,” and “grammarString” which specifies an X+V grammar string. Clicking on the item name “BICYCLE” may take a user to the interface 404.

With reference to FIG. 4B, the interface 404 presents to a warehouse worker information related to picking a quantity of the item “BICYCLE.” The interface 404 requires the worker to scan a barcode on a bicycle that the worker picks, as represented by a barcode ID string field 418. The barcode ID string field 418 may be implemented by an xv:input-scan field. The xv:input scan tag provides functionality to a field to read in and display data from a barcode scanner or other suitable scanner (e.g. an RFID tag scanner). The xv:input-scan tag may include such attributes as: “inputID,” “next,” “prompt,” “submit,” “value,” and “size.”

Once the worker has completed picking the required quantity of the bicycle, he/she may select (by clicking or by saying “submit”) a submit button 420 to update the inventory information. The submit button 420 may be implemented using an xv:submit tag. The xv:submit tag may include such attributes as: “inputID,” “nextFocus” which provides an optional value for a next element if a user does not want to submit, “buttonValue” which provides an optional value for a custom button name, “prompt,” and “promptBeforeSubmit” which provides an optional voice prompt before submitting.

A number of implementations have been described. Nevertheless, it will be understood that various modifications may be made. For example, various operations in the disclosed processes may be performed in different orders or in parallel, and various features and components in the disclosed implementations may be combined, deleted, rearranged, or supplemented. Accordingly, other implementations are within the scope of the following claims.

What is claimed is:

1. A multimodal system comprising:
a user device including a multimodal browser operable to receive web content in a multimodal markup language for presentation;
a multimodal application including interfaces implemented as server pages using multimodal markup language tags including tag attributes, wherein the multimodal markup language tags are operable to present interface elements of the server pages in one or more modes and further wherein the multimodal markup language tags are operable to accept input associated with the interface elements in one or more input modalities; and
an application server operable to process the multimodal markup language tags such that the server pages implemented using the multimodal markup language tags can be displayed on the multimodal browser.

2. The system of claim 1 wherein the server pages are Java Server Pages (JSPs).

3. The system of claim 1 wherein the tag attributes relate to a type, format, or appearance associated with the interface elements of the server pages.

4. The system of claim 1 wherein the application server includes:
a tag library operable to define the multimodal markup language tags used to implement the server pages;
a servlet container operable to evaluate the multimodal markup language tags; and
web templates operable to be populated with attribute values extracted from the multimodal markup language tags.

5. The system of claim 4 wherein the tag library includes:
a tag library descriptor file (TLD) operable to describe the multimodal markup language tags used to implement the interfaces; and
tag handlers operable to define functionality associated with each of the multimodal markup language tags.

6. The system of claim 4 wherein the servlet container is a JSP container.

7. A method comprising:
providing a multimodal markup language tag having one or more attribute values, the tag being used to implement a server page;
calling a tag handler associated with the multimodal markup language tag;
extracting the one or more attribute values from the multimodal markup language tag;
selecting a web template associated with the multimodal markup language tag; and
populating the web template with the attribute values.

8. The method of claim 7 further comprising:
writing the template contents to a writer; and
compiling and executing a servlet associated with the server page.

9. The method of claim 8 wherein the writer is a JSPWriter.

10. A system comprising:
a mobile device including a multimodal browser operable to present web content implemented using extensible hypertext markup language plus voice (X+V);
an application developed using X+V tags operable to implement a voice-enabled and/or multimodal user interface;
a tag library operable to store a set of X+V tags;
web templates written in X+V code and associated with the set of X+V tags; and
an X+V tag handler operable to interpret an X+V tag, read one or more attribute values associated with the X+V tag, and populate the one or more attribute values with one or more of the web templates, wherein using the one or more of the web templates, X+V code is generated to create voice-enabled and/or multimodal web content.

11. The system of claim 10 wherein the set of X+V tags is developed based on various usage scenarios of the system.

12. The system of claim 10 wherein the set of X+V tags is developed using a Java Server Page tag library schema.

13. The system of claim 10 wherein the set of X+V tags includes an xv:head tag operable to write out standard X+V header tags.

14. The system of claim 10 wherein the set of X+V tags includes an xv:input tag operable to provide functionality to voice-enable text-input field.

15. The system of claim 10 wherein the set of X+V tags includes an xv:input-checkbox tag operable to provide functionality to voice-enable a checkbox.

16. The system of claim 10 wherein the set of X+V tags includes an xv:input-built-in tag operable to provide functionality to voice-enable an input field using one of a variety of built-in VoiceXML types.

17. The system of claim 10 wherein the set of X+V tags includes an xv:message tag operable to display an acoustic message to a user without requiring receipt of feedback from the user.

18. The system of claim 10 wherein the set of X+V tags includes an xv:confirmation tag operable to provide confirmation functionality to voice-enabled X+V interface elements.

19. The system of claim 10 wherein the set of X+V tags includes an xv:listselector tag operable to voice-enable a set of links.

20. The system of claim 10 wherein the set of X+V tags includes an xv:submit tag operable to provide functionality to voice-enable a submit button.

21. The system of claim 10 wherein the set of X+V tags includes an xv:input-scan tag operable to read data from a barcode into a barcode string field.

22. The system of claim 10 wherein the set of X+V tags includes an xv:input-builtin-restricted tag operable to enable restricted input of numbers into a text field.

23. The system of claim 10 wherein the tag library includes:
a tag library descriptor file (TLD) operable to describe the multimodal markup language tags used to implement the interfaces; and
tag handlers operable to define functionality associated with each of the multimodal markup language tags.
